(19) United States
(12) Patent Application Publication
(10) Pub. No.: US 2026/0348868 A1
(43) Pub. Date: Nov. 5, 2026

(54) APPEARANCE INSPECTION DEVICE AND APPEARANCE INSPECTION METHOD

(71) Applicant: SUMCO CORPORATION, Tokyo (JP)

(72) Inventors: Toshio HAYASHIDA, Tokyo (JP); Shuichi OMOTE, Tokyo (JP); Takashi IWAMOTO, Tokyo (JP)

(73) Assignee: SUMCO CORPORATION, Tokyo (JP)

(21) Appl. No.: 19/486,772

(22) PCT Filed: Apr. 16, 2024
(86) PCT No.: PCT/JP2024/015199

§ 371 Date: Nov. 21, 2025

(30) Foreign Application Priority Data
Jun. 1, 2023 (JP) 2023-090927

(51) Int. Cl. G01N 21/88; G01N 21/952

(52) U.S. Cl. CPC G01N 21/8851; G01N 21/952; G01N 2201/103

(57) ABSTRACT

An appearance inspection device configured to inspect an appearance of a solid or hollow cylindrical inspection object includes: a rotation mechanism configured to rotate the inspection object in a circumferential direction of the inspection object; a sensor configured to irradiate, with laser light, a surface of the inspection object being rotated in the circumferential direction and to receive reflected light of the laser light reflected by the surface of the inspection object; an image processing unit configured to generate a height image of the surface based on a light-receiving state of the reflected light; and a determination unit configured to determine a characteristic of the surface based on the height image.

### TECHNICAL FIELD

The present invention relates to an appearance inspection device and an appearance inspection method.

### BACKGROUND ART

There are known inspection methods for silicon single crystals manufactured by the Czochralski method (see, for example, Patent Literatures 1 and 2).

Patent Literature 1 discloses a method in which the shape of a V-notch formed in a longitudinal direction of a silicon single crystal ingot is scanned using an optical measuring means, evaluation data is generated by performing a coordinate transformation on the V-notch shape data obtained by the scanning, and the quality of the V-notch shape is determined based on the generated evaluation data.

Patent Literature 2 discloses a method in which, after performing heat treatment of a p-type silicon single crystal in a nitrogen atmosphere, the distribution of crystal defects caused by vacancies in the silicon single crystal is measured, thereby specifying a region in the silicon single crystal in which vacancies are excessive.

Further, Patent Literature 3 relating to a cleaning apparatus for a silicon single crystal block cut from a silicon single crystal discloses automatically inspecting the appearance of the silicon single crystal block cleaned by the cleaning apparatus.

### CITATION LIST

### Patent Literature(S)

Patent Literature 1: JP 2020-043205 A

Patent Literature 2: JP 2018-186195 A

Patent Literature 3: JP 2011-143321 A

### SUMMARY OF THE INVENTION

### Problem(s) To Be Solved By The Invention

However, Patent Literatures 1 and 2 do not disclose a method for inspecting the appearance of a silicon single crystal. In addition, although Patent Literature 3 discloses automatically inspecting the appearance of a silicon single crystal block, no specific method is disclosed.

An object of the invention is to provide an appearance inspection device and an appearance inspection method capable of appropriately inspecting the appearance of a solid or hollow cylindrical inspection object.

### Means For Solving The Problem(s)

According to an aspect of the invention, an appearance inspection device configured to inspect an appearance of a solid or hollow cylindrical inspection object includes: a rotation mechanism configured to rotate the inspection object in a circumferential direction of the inspection object; a sensor configured to irradiate, with laser light, a surface of the inspection object being rotated in the circumferential direction and to receive reflected light of the laser light reflected by the surface of the inspection object; an image processing unit configured to generate a height image of the surface based on a light-receiving state of the reflected light; and a determination unit configured to determine a characteristic of the surface based on the height image.

It is preferable that the appearance inspection device according to the aspect of the invention further includes a sensor moving mechanism configured to move the sensor along the surface, in which the rotation mechanism is configured to rotate the inspection object one revolution at a time in the circumferential direction, the sensor is configured to irradiate the surface with the laser light and to receive the reflected light reflected by the surface of the inspection object while the inspection object makes one revolution, and the sensor moving mechanism is configured to move the sensor along the surface by a predetermined distance each time the inspection object makes one revolution.

In the appearance inspection device according to the aspect of the invention, the rotation mechanism is preferably configured to change a rotation direction to an opposite direction each time the inspection object is rotated one revolution in an identical direction for a predetermined number of times.

In the appearance inspection device according to the aspect of the invention, it is preferable that the sensor is a single sensor, the surface includes an outer peripheral surface and an end surface, and the sensor moving mechanism is configured to move the single sensor along the outer peripheral surface in a direction parallel to a central axis of the inspection object, and to move the single sensor along the end surface in a radial direction of the inspection object.

In the appearance inspection device according to the aspect of the invention, it is preferable that the sensor includes a first sensor and a second sensor, the surface includes an outer peripheral surface and an end surface, and the sensor moving mechanism includes a first moving mechanism configured to move the first sensor along the outer peripheral surface in a direction parallel to a central axis of the inspection object; and a second moving mechanism configured to move the second sensor along the end surface in a radial direction of the inspection object.

In the appearance inspection device according to the aspect of the invention, the laser light is preferably blue laser light.

In the appearance inspection device according to the aspect of the invention, it is preferable that the image processing unit is configured to generate a two-dimensional image of the surface based on the light-receiving state of the reflected light, and the determination unit is configured to specify an abnormal portion on the surface based on the two-dimensional image, and to determine whether a defect is present on the surface based on the height image of the abnormal portion specified.

According to an another aspect of the invention, an appearance inspection method for inspecting an appearance of a solid or hollow cylindrical inspection object includes: performing a surface inspection by rotating the inspection object one revolution in a circumferential direction thereof, irradiating a surface of the inspection object being rotated in the circumferential direction with laser light from a sensor, and receiving reflected light of the laser light reflected by the surface of the inspection object with the sensor; performing an image generation by generating a height image of the surface based on a light-receiving state of the reflected light; and performing a determination by determining a characteristic of the surface based on the height image.

In the appearance inspection method according to the another aspect of the invention, the surface inspection preferably includes rotating the inspection object one revolution in the circumferential direction and then stopping the inspection object. Here, it is preferably repeated a process of: while the inspection object makes one revolution, irradiating the surface with the laser light from the sensor and receiving the reflected light reflected by the surface with the sensor; and when the inspection object has stopped, moving the sensor along the surface by a predetermined distance.

In the appearance inspection method according to the another aspect of the invention, it is preferable that the sensor is a single sensor, the surface includes an outer peripheral surface and an end surface, the surface inspection includes an outer peripheral surface inspection and an end surface inspection performed before or after the outer peripheral surface inspection, and the outer peripheral surface inspection includes rotating the inspection object one revolution in the circumferential direction and then stopping the inspection object. Here, it is preferably repeated a process of: while the inspection object makes one revolution, irradiating the outer peripheral surface with the laser light from the single sensor and receiving the reflected light reflected by the outer peripheral surface with the single sensor; and when the inspection object has stopped, moving the single sensor along the outer peripheral surface by a predetermined distance in a direction parallel to a central axis of the inspection object. The end surface inspection preferably includes rotating the inspection object one revolution in the circumferential direction and then stopping the inspection object. Here, it is preferably repeated a process of: while the inspection object makes one revolution, irradiating the end surface with the laser light from the single sensor and receiving the reflected light reflected by the end surface with the single sensor; and when the inspection object has stopped, moving the single sensor along the end surface by a predetermined distance in a radial direction of the inspection object.

In the appearance inspection method according to the another aspect of the invention, it is preferable that the sensor includes a first sensor and a second sensor, the surface includes an outer peripheral surface and an end surface, and the surface inspection includes rotating the inspection object one revolution in the circumferential direction and then stopping the inspection object. Here, it is preferably repeated a process of: while the inspection object makes one revolution, irradiating the outer peripheral surface with the laser light from the first sensor and receiving the reflected light reflected by the outer peripheral surface with the first sensor, and irradiating the end surface with the laser light from the second sensor and receiving the reflected light reflected by the end surface with the second sensor; and when the inspection object has stopped, moving the first sensor along the outer peripheral surface by a first distance in a direction parallel to a central axis of the inspection object and moving the second sensor along the end surface by a second distance in a radial direction of the inspection object.

In the appearance inspection method according to the another aspect of the invention, the surface inspection preferably includes changing a rotation direction of the inspection object to an opposite direction each time the inspection object is rotated one revolution in an identical direction for a predetermined number of times.

In the appearance inspection method according to the another aspect of the invention, the inspection object is preferably a silicon single crystal block having the solid cylindrical shape obtained by cutting a silicon single crystal.

In the appearance inspection method according to the another aspect of the invention, the surface inspection preferably includes detecting a notch of the silicon single crystal block when the inspection object is rotated one revolution in the circumferential direction, and rotating the silicon single crystal block one revolution with reference to the notch.

In the appearance inspection method according to the another aspect of the invention, the laser light is preferably blue laser light.

In the appearance inspection method according to the another aspect of the invention, it is preferable that the image generation includes generating a two-dimensional image of the surface based on the light-receiving state of the reflected light, and the determination includes specifying an abnormal portion on the surface based on the two-dimensional image, and determining whether a defect is present on the surface based on the height image of the abnormal portion specified.

### BRIEF EXPLANATION OF DRAWINGS

FIG. 1 is a perspective view illustrating a schematic configuration of an appearance inspection device according to a first exemplary embodiment.

FIG. 2 is a block diagram illustrating a schematic configuration of a control system of the appearance inspection device according to the first exemplary embodiment.

FIG. 3 schematically illustrates a movement state of a sensor during inspection according to the first exemplary embodiment.

FIG. 4A schematically illustrates an irradiation range on an outer peripheral surface of blue laser light used for inspection according to the first exemplary embodiment.

FIG. 4B schematically illustrates an irradiation range on an end surface of blue laser light used for inspection according to the first exemplary embodiment.

FIG. 5A schematically illustrates a two-dimensional image used for inspection according to the first exemplary embodiment.

FIG. 5B schematically illustrates a height image used for inspection according to the first exemplary embodiment.

FIG. 5C schematically illustrates a cross-sectional shape image used for inspection according to the first exemplary embodiment.

FIG. 6 is a flowchart of an appearance inspection process according to the first exemplary embodiment.

FIG. 7 is another flowchart of the appearance inspection process according to the first and second exemplary embodiments.

FIG. 8 is a flowchart of an inspection process of the outer peripheral surface according to the first exemplary embodiment.

FIG. 9 is a flowchart of an inspection process of the end surface according to the first exemplary embodiment.

FIG. 10 is a perspective view illustrating a schematic configuration of an appearance inspection device according to a second exemplary embodiment.

FIG. 11 is a block diagram illustrating a schematic configuration of a control system of the appearance inspection device according to the second exemplary embodiment.

FIG. 12A schematically illustrates a movement state of a sensor during inspection of an outer peripheral surface according to the second exemplary embodiment.

FIG. 12B schematically illustrates a movement state of a sensor during inspection of an end surface according to the second exemplary embodiment.

FIG. 13 is a flowchart of an appearance inspection process according to the second exemplary embodiment.

FIG. 14 is a flowchart of an inspection process of the outer peripheral surface and the end surface according to the second exemplary embodiment.

FIG. 15 is another flowchart of the inspection process of the outer peripheral surface and the end surface according to the second exemplary embodiment.

### DESCRIPTION OF EMBODIMENT(S)

### First Exemplary Embodiment

### Configuration of Appearance Inspection Device

First, configurations of an appearance inspection device according to a first exemplary embodiment of the invention will be described.

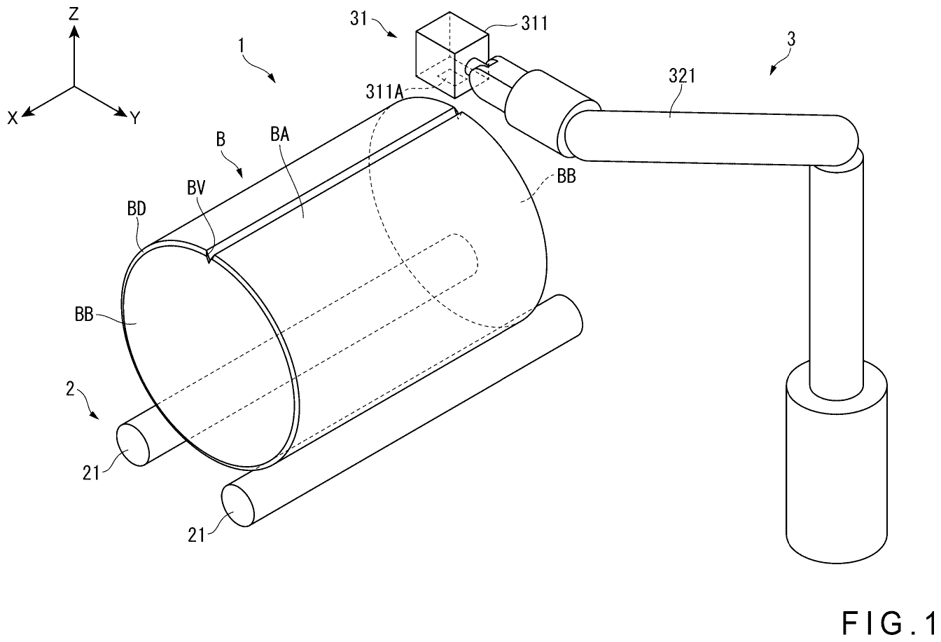

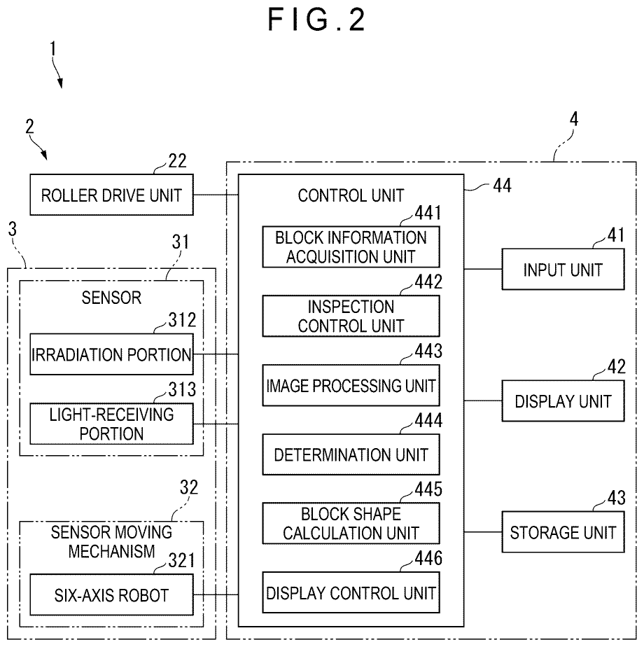

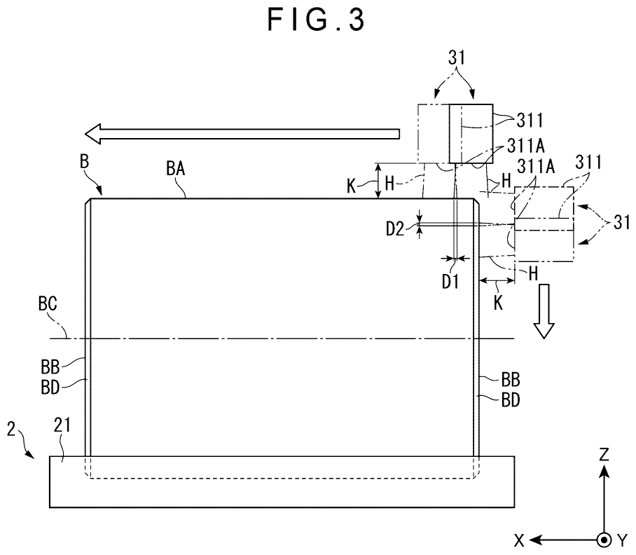

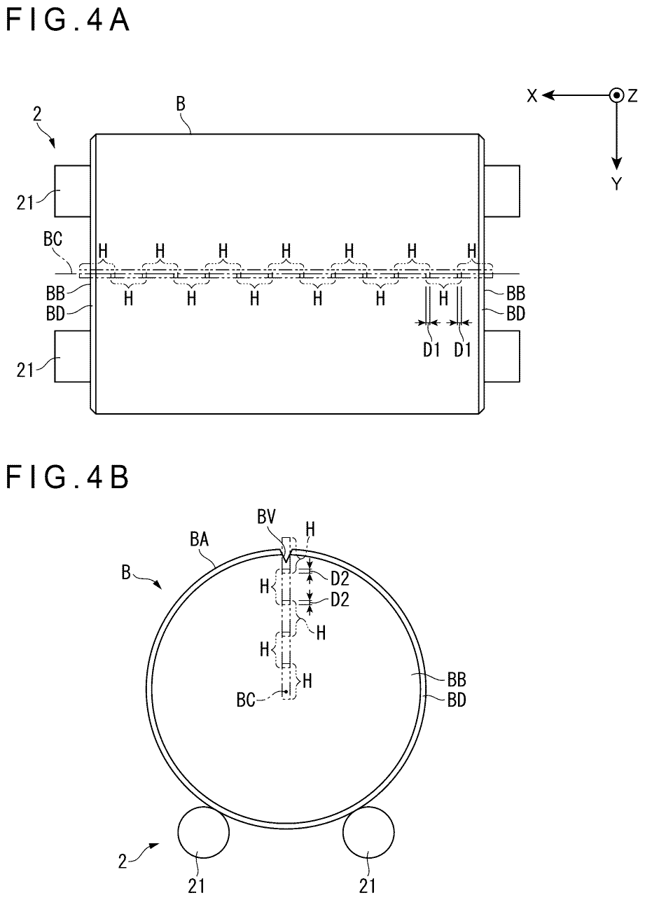

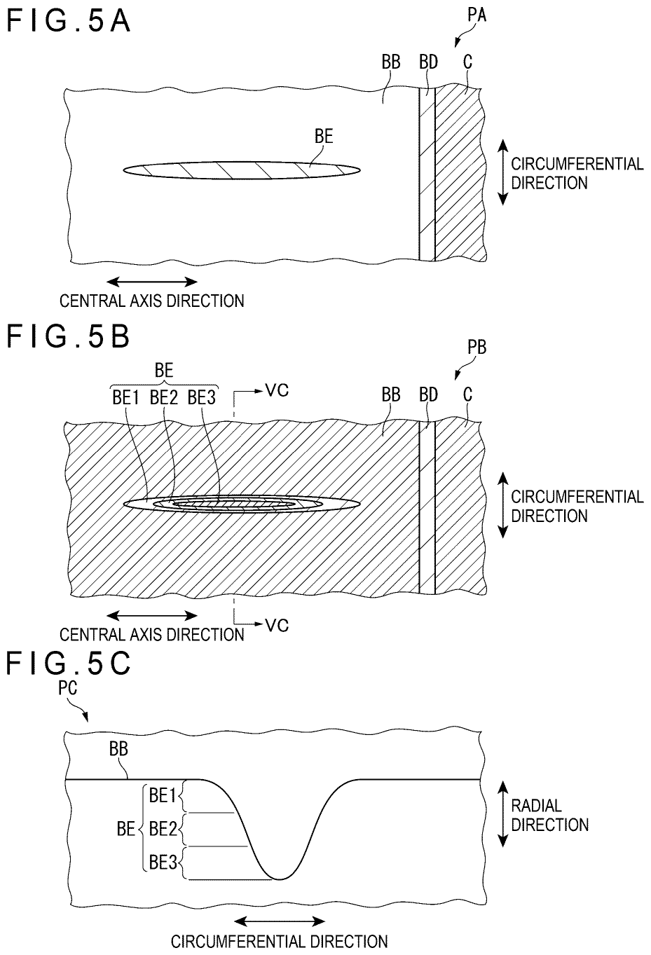

FIG. 1 is a perspective view illustrating a schematic configuration of the appearance inspection device of the first exemplary embodiment. FIG. 2 is a block diagram illustrating a schematic configuration of a control system of the appearance inspection device. FIG. 3 schematically illustrates a movement state of a sensor during inspection. FIG. 4A schematically illustrates an irradiation range on an outer peripheral surface of blue laser light used for inspection. FIG. 4B schematically illustrates an irradiation range on an end surface of blue laser light used for inspection. FIG. 5A schematically illustrates a two-dimensional image used for inspection. FIG. 5B schematically illustrates a height image used for inspection. FIG. 5C schematically illustrates a cross-sectional shape image used for inspection.

In the following description, each configuration may be described based on the XYZ coordinate system illustrated in FIG. 1, in which the X-axis direction represents a front-rear direction, the Y-axis direction represents a left-right direction, and the Z-axis direction represents an up-down direction.

An appearance inspection device 1 illustrated in FIG. 1 inspects the appearance of a silicon single crystal block B serving as a solid cylindrical inspection object.

The silicon single crystal block B is obtained by at least performing a known cylindrical grinding step on an outer peripheral surface and a chamfering step on corner portions at both ends in a crystal axis direction (a longitudinal direction of the silicon single crystal block B), after being cut into a cylindrical shape from a silicon single crystal manufactured by the Czochralski method.

A notch BV is formed along the longitudinal direction of the silicon single crystal block B on an outer peripheral surface BA as a surface of the silicon single crystal block B.

As an example of the size of the silicon single crystal block B, a diameter R may be 100 mm or more and 450 mm or less, and a length L may be 50 mm or more and 500 mm or less.

As illustrated in FIGS. 1 and 2, the appearance inspection device 1 includes a rotation mechanism 2, an inspection unit 3, and a controller 4.

The rotation mechanism 2 rotates the silicon single crystal block B in a circumferential direction of the silicon single crystal block B. The rotation mechanism 2 includes a pair of rotation rollers 21 and a roller drive unit 22 that drives the pair of rotation rollers 21.

The pair of rotation rollers 21 are disposed to be rotatable about rotation axes extending in the front-rear direction while being spaced apart from each other by a predetermined distance so as to be horizontal to each other. The pair of rotation rollers 21 support the outer peripheral surface BA of the silicon single crystal block B from below.

The roller drive unit 22, under the control of the controller 4, rotates the pair of rotation rollers 21 in the same direction, thereby rotating the silicon single crystal block B in the circumferential direction of the silicon single crystal block B.

The inspection unit 3 includes a single sensor 31 and a sensor moving mechanism 32.

The sensor 31 is constituted by a laser displacement sensor, and includes a sensor main body 311, an irradiation portion 312, and a light-receiving portion 313.

The sensor main body 311 includes a light entrance/exit surface portion 311A.

The irradiation portion 312 is disposed in the sensor main body 311. The irradiation portion 312 continuously irradiates blue laser light under the control of the controller 4. The irradiation portion 312 may also intermittently irradiate blue laser light at predetermined intervals. As illustrated in FIG. 3, when a distance from the light entrance/exit surface portion 311A to the outer peripheral surface BA is an inspection distance K, the blue laser light irradiated from the light entrance/exit surface portion 311A is irradiated so that a length of a line-shaped irradiation range H becomes shorter than a length in the front-rear direction of the outer peripheral surface BA. When a distance from the light entrance/exit surface portion 311A to an end surface BB is the inspection distance K, the blue laser light is irradiated so that a length of the irradiation range H becomes shorter than a radius of the end surface BB.

The light-receiving portion 313 is disposed in the sensor main body 311. The light-receiving portion 313 receives reflected light of the blue laser light irradiated from the light entrance/exit surface portion 311A and reflected by the outer peripheral surface BA or the end surface BB, and outputs a signal corresponding to a light-receiving state to the controller 4. Hereinafter, the “reflected light of the blue laser light” may be simply referred to as “reflected light.”

The sensor moving mechanism 32 includes a six-axis robot 321. The six-axis robot 321 holds the sensor 31 and is configured to freely change a position and an orientation of the light entrance/exit surface portion 311A with respect to the silicon single crystal block B. The six-axis robot 321, under the control of the controller 4, moves the sensor 31 in the front-rear direction above the silicon single crystal block B. That is, the six-axis robot 321 moves the sensor 31 along the outer peripheral surface BA in a direction parallel to a central axis BC of the silicon single crystal block B. The six-axis robot 321, under the control of the controller 4, moves the sensor 31 in the up-down direction at a position facing the end surface BB on a rear side (−X direction side) of the silicon single crystal block B.

As illustrated in FIG. 2, the controller 4 includes an input unit 41, a display unit 42, a storage unit 43, and a control unit 44. The control unit 44 is electrically connected to the roller drive unit 22, the irradiation portion 312, the light-receiving portion 313, the six-axis robot 321, the input unit 41, the display unit 42, and the storage unit 43.

The input unit 41 includes, for example, a touch panel or physical buttons. The input unit 41 is used for inputting various kinds of information and outputs a signal corresponding to the input to the control unit 44.

The display unit 42 displays various kinds of information under the control of the control unit 44.

The storage unit 43 includes a known storage device such as a hard disk drive (HDD). The storage unit 43 stores various kinds of information necessary for inspection of the silicon single crystal block B.

The control unit 44 includes a central processing unit (CPU). The control unit 44 functions as a block information acquisition unit 441, an inspection control unit 442, an image processing unit 443, a determination unit 444, a block shape calculation unit 445, and a display control unit 446, by the CPU executing an inspection control program stored in the storage unit 43.

The block information acquisition unit 441 acquires block information for specifying the silicon single crystal block B to be inspected. The block information acquisition unit 441 may acquire block information input through a user operation on the input unit 41, or may acquire block information read by a code reader from, for example, a two-dimensional code displayed on the end surface BB of the silicon single crystal block B.

The inspection control unit 442 controls the roller drive unit 22 and the six-axis robot 321 to inspect the outer peripheral surface BA and the end surface BB of the silicon single crystal block B.

When inspecting the outer peripheral surface BA, the inspection control unit 442 controls the six-axis robot 321 to position the sensor 31 at a first inspection position of the outer peripheral surface in a state where the light entrance/exit surface portion 311A faces the outer peripheral surface BA above the silicon single crystal block B. As illustrated by solid lines in FIGS. 3 and 4A, the first inspection position of the outer peripheral surface is a position where a rear end of the irradiation range H is located rearward of a rear end surface BB, a front end of the irradiation range H is located on the outer peripheral surface BA, and a distance from the light entrance/exit surface portion 311A to the outer peripheral surface BA becomes the inspection distance K. It should be noted that, in FIG. 4A, the irradiation range H is illustrated as a rectangle with its short sides parallel to the left-right direction for ease of understanding of the first exemplary embodiment, but the actual irradiation range H is line-shaped extending in the front-rear direction. The inspection control unit 442 controls the roller drive unit 22 to rotate the silicon single crystal block B one revolution about the central axis BC and causes the irradiation portion 312 to irradiate the outer peripheral surface BA with blue laser light.

When the inspection control unit 442 acquires a signal corresponding to a light-receiving state from the light-receiving portion 313 that has received reflected light reflected by the outer peripheral surface BA, the inspection control unit 442 associates information on the light-receiving state at each rotation angle, positional information of the first inspection position of the outer peripheral surface, and block information of the silicon single crystal block B to be inspected, and stores them as first inspection information of the outer peripheral surface in the storage unit 43.

Subsequently, the inspection control unit 442 controls the six-axis robot 321 to sequentially move the sensor 31 along the central axis BC to an N-th (N is an integer of 2 or greater) inspection position of the outer peripheral surface while maintaining a state in which the light entrance/exit surface portion 311A faces the outer peripheral surface BA and while maintaining a distance from the light entrance/exit surface portion 311A to the outer peripheral surface BA at the inspection distance K. When the sensor 31 is at the N-th inspection position of the outer peripheral surface, the irradiation range H is located at a position indicated by a two-dot chain line. The N-th inspection position of the outer peripheral surface is a position located forward of the (N−1)-th inspection position of the outer peripheral surface, where an overlap width between the irradiation range H of the blue laser light irradiated from the N-th inspection position of the outer peripheral surface and the irradiation range H of the blue laser light irradiated from the (N−1)-th inspection position of the outer peripheral surface becomes a width D1. The width D1 is a value greater than 0 mm. Each time the sensor 31 is at the N-th inspection position of the outer peripheral surface, the inspection control unit 442 rotates the silicon single crystal block B one revolution and causes the irradiation portion 312 to irradiate the outer peripheral surface BA with blue laser light.

Each time the inspection control unit 442 causes the irradiation portion 312 to irradiate blue laser light at the N-th inspection position of the outer peripheral surface, the inspection control unit 442 associates information on the light-receiving state at each rotation angle, positional information of the N-th inspection position of the outer peripheral surface, and block information, and stores them as N-th inspection information of the outer peripheral surface in the storage unit 43.

As illustrated in FIG. 4A, the inspection control unit 442 repeats the above-described process until inspection is completed in a state where the front end of the irradiation range H is located forward of a front end surface BB and the rear end of the irradiation range H is located on the outer peripheral surface BA. In the example illustrated in FIG. 4A, the inspection control unit 442 repeats the above-described process until inspection is completed in a state where the sensor 31 is located at the thirteenth inspection position of the outer peripheral surface.

When inspecting the end surface BB, the inspection control unit 442 controls the six-axis robot 321 to position the sensor 31 at a first inspection position of the end surface in a state where the light entrance/exit surface portion 311A faces the end surface BB. As illustrated by a one-dot chain line in FIGS. 3 and 4B, the first inspection position of the end surface is a position where an upper end of the irradiation range H is located above the outer peripheral surface BA, a lower end of the irradiation range H is located on the end surface BB, and a distance from the light entrance/exit surface portion 311A to the end surface BB becomes the inspection distance K. It should be noted that, in FIG. 4B, the irradiation range H is illustrated as a rectangle with its short sides parallel to the left-right direction for ease of understanding of the first exemplary embodiment, but the actual irradiation range H is line-shaped extending in the up-down direction. The inspection control unit 442 rotates the silicon single crystal block B one revolution and causes the irradiation portion 312 to irradiate the end surface BB with blue laser light.

When the inspection control unit 442 acquires a signal corresponding to a light-receiving state from the light-receiving portion 313 that has received reflected light reflected by the end surface BB, the inspection control unit 442 associates information on the light-receiving state at each rotation angle, positional information of the first inspection position of the end surface, and block information, and stores them as first inspection information of the end surface in the storage unit 43.

Subsequently, the inspection control unit 442 controls the six-axis robot 321 to sequentially move the sensor 31 along a vertical direction to an M-th (M is an integer of 2 or greater) inspection position of the end surface while maintaining a state in which the light entrance/exit surface portion 311A faces the end surface BB and while maintaining a distance from the light entrance/exit surface portion 311A to the end surface BB at the inspection distance K. When the sensor 31 is at the M-th inspection position of the end surface, the irradiation range H is located at a position indicated by a two-dot chain line. The M-th inspection position of the end surface is a position located below the (M−1)-th inspection position of the end surface, where an overlap width between the irradiation range H of the blue laser light irradiated from the M-th inspection position of the end surface and the irradiation range H of the blue laser light irradiated from the (M−1)-th inspection position of the end surface becomes a width D2. The width D2 is a value greater than 0 mm, and may be the same as the width D1 or may be different from the width D1. Each time the sensor 31 is at the M-th inspection position of the end surface, the inspection control unit 442 rotates the silicon single crystal block B one revolution and causes the irradiation portion 312 to irradiate the end surface BB with blue laser light.

Each time the inspection control unit 442 causes the irradiation portion 312 to irradiate blue laser light at the M-th inspection position of the end surface, the inspection control unit 442 associates information on the light-receiving state at each rotation angle, positional information of the N-th inspection position of the end surface, and block information, and stores them as M-th inspection information of the end surface in the storage unit 43.

As illustrated in FIG. 4B, the inspection control unit 442 repeats the above-described process until inspection is completed in a state where the lower end of the irradiation range H is located below the central axis BC and the upper end of the irradiation range H is located above the central axis BC. In the example illustrated in FIG. 4B, the inspection control unit 442 repeats the above-described process until inspection is completed in a state where the sensor 31 is located at the fifth inspection position of the end surface.

The image processing unit 443 generates a two-dimensional image PA illustrated in FIG. 5A and a height image PB illustrated in FIG. 5B, based on the light-receiving state of reflected light at the light-receiving portion 313 for each rotation angle represented by inspection information of each inspection position of the outer peripheral surface or inspection information of each inspection position of the end surface. In the two-dimensional image PA of FIG. 5A and the height image PB of FIG. 5B, an up-down direction corresponds to the circumferential direction of the silicon single crystal block B, and a left-right direction corresponds to a direction of the central axis BC.

The image processing unit 443 generates a cross-sectional shape image PC illustrated in FIG. 5C based on the height image PB.

The two-dimensional image PA represents characteristics of the outer peripheral surface BA or the end surface BB irradiated with blue laser light in black-and-white shading. The two-dimensional image PA represents, for example, the characteristics of the outer peripheral surface BA or the end surface BB in black-and-white shading corresponding to a distance from the reference surface, which is the outer peripheral surface BA or the end surface BB, to the sensor 31.

For example, in the two-dimensional image PA illustrated in FIG. 5A, which is generated based on the first inspection information of the outer peripheral surface, the outer peripheral surface BA is represented by a white region. A chamfered portion BD of the silicon single crystal block B is represented by a first gray region extending linearly in the circumferential direction at one end of the white region in the direction of the central axis BC. A region C with no inspection object in which the silicon single crystal block B is absent is represented by a black region located on the other end side of the white region in the direction of the central axis BC with respect to the first gray region.

An abnormal portion BE may be present on the outer peripheral surface BA, on the chamfered portion BD, or at a boundary between the outer peripheral surface BA and the chamfered portion BD. The abnormal portion BE is a protruding portion where foreign matter such as dirt adheres, or a recessed portion where a defect such as a scratch, crack, chip, or residual skin is present. The residual skin refers to a portion that has not been ground in cylindrical grinding.

In the two-dimensional image PA, the abnormal portion BE is represented by a second gray region. The darkness of the second gray region corresponds to a height or depth of the abnormal portion BE, and may be different from or the same as the darkness of the first gray region.

In the two-dimensional image PA, the abnormal portion BE is represented in gray shading (gradation of gray) corresponding to its height or depth. Thus, using the two-dimensional image PA for a determination process of determining whether the abnormal portion BE is foreign matter or a defect may make the determination difficult.

The height image PB represents characteristics of the outer peripheral surface BA or the end surface BB in color. The height image PB represents, for example, the characteristics of the outer peripheral surface BA or the end surface BB in hue, brightness, and saturation corresponding to a distance from the reference surface, which is the outer peripheral surface BA or the end surface BB, to the sensor 31.

For example, in the height image PB illustrated in FIG. 5B, which is generated based on the first inspection information of the outer peripheral surface, the abnormal portion BE is represented in a color in which at least one of hue, brightness, or saturation differs, depending on a depth relative to the outer peripheral surface BA when the abnormal portion BE is a defect occurrence region, or depending on a height relative to the outer peripheral surface BA when the abnormal portion BE is a foreign matter adhesion region. When the abnormal portion BE illustrated in FIG. 5B is a defect occurrence region, for example, a shallow portion BE1, an intermediate portion BE2 deeper than the shallow portion BE1, and a deep portion BE3 deeper than the intermediate portion BE2 are represented in colors in which at least one of hue, brightness, or saturation differs.

In the height image PB, the outer peripheral surface BA, the chamfered portion BD, the region C with no inspection object, and the abnormal portion BE to which foreign matter adheres are represented in colors having hue, brightness, and saturation corresponding to a height or depth relative to the outer peripheral surface BA.

In the height image PB, the abnormal portion BE is represented in a color in which at least one of hue, brightness, or saturation differs according to its height or depth. Thus, using the height image PB for a determination process of the abnormal portion BE makes the determination easier than a case using the two-dimensional image PA.

The cross-sectional shape image PC represents a cross-sectional shape of a defect generated in the abnormal portion BE. The cross-sectional shape image PC of FIG. 5C represents a cross-sectional shape of the abnormal portion BE along a VC-VC line parallel to the circumferential direction in FIG. 5B. In the cross-sectional shape image PC, the defect of the abnormal portion BE is represented by lines corresponding to shapes of the shallow portion BE1, the intermediate portion BE2, and the deep portion BE3. In the cross-sectional shape image PC of FIG. 5C, an up-down direction corresponds to a radial direction of the silicon single crystal block B, and a left-right direction corresponds to the circumferential direction.

The cross-sectional shape image PC may also represent a cross-sectional shape of the abnormal portion BE along a line inclined to or orthogonal to the circumferential direction.

The image processing unit 443 also generates, although not illustrated, the two-dimensional image PA, the height image PB, and the cross-sectional shape image PC representing states of the end surface BB, the chamfered portion BD, the region C with no inspection object, and the abnormal portion BE, based on inspection information of each inspection position of the end surface.

If the irradiation range H corresponding to the inspection position of the outer peripheral surface in the inspection information of the outer peripheral surface includes a region located outside the end surface BB, the chamfered portion BD and the region C with no inspection object are present in the two-dimensional image PA and the height image PB. On the other hand, if the irradiation range H does not include a region located outside the end surface BB, the chamfered portion BD and the region C with no inspection object are not present in the two-dimensional image PA and the height image PB. If the irradiation range H corresponding to the inspection position of the end surface in the inspection information of the end surface includes a region located outside the outer peripheral surface BA, the chamfered portion BD and the region C with no inspection object are present in the two-dimensional image PA and the height image PB. On the other hand, if the irradiation range H does not include a region located outside the outer peripheral surface BA, the chamfered portion BD and the region C with no inspection object are not present in the two-dimensional image PA and the height image PB.

The determination unit 444 specifies the abnormal portion BE on the outer peripheral surface BA or the end surface BB based on the two-dimensional image PA. When the determination unit 444 detects that the second gray region representing the abnormal portion BE is present within the white region representing the outer peripheral surface BA or the end surface BB in the two-dimensional image PA, the determination unit 444 determines that the abnormal portion BE is present on the outer peripheral surface BA or the end surface BB.

When the determination unit 444 determines, based on the two-dimensional image PA, that the abnormal portion BE is present, the determination unit 444 determines, based on the height image PB including the abnormal portion BE, whether foreign matter or a defect exists in the abnormal portion BE as a characteristic of the outer peripheral surface BA or the end surface BB. When the determination unit 444 detects that the color of the region representing the abnormal portion BE in the height image PB indicates a level higher than that of the outer peripheral surface BA or the end surface BB, the determination unit 444 determines that foreign matter exists in the abnormal portion BE. Conversely, when the color indicates a level lower than that of the outer peripheral surface BA or the end surface BB, the determination unit 444 determines that a defect exists in the abnormal portion BE.

When the determination unit 444 determines that a defect is present in the abnormal portion BE, the determination unit 444 determines that the defect is one of a scratch, a crack, a chip, or a residual skin, that is, it determines the type of the defect. When determining the type of the defect, the determination unit 444 makes the determination based on at least one parameter among the length, area, depth, and inclination angle of the defect. The determination unit 444 calculates at least one of the length, area, or depth of the defect based on the height image PB. The determination unit 444 calculates at least the inclination angle among the depth and inclination angle of the defect based on the cross-sectional shape image PC.

When at least one of the parameters is equal to or greater than a threshold value preset in the determination unit 444, the determination unit 444 may determine that the defect is an unacceptable defect. When the parameter is less than the threshold value, the determination unit 444 may determine that the defect is an acceptable defect.

The block shape calculation unit 445 calculates the length in the direction of the central axis BC and the diameter of the silicon single crystal block B based on the two-dimensional image PA, the height image PB, or a movement distance of the sensor 31 during inspection.

The display control unit 446 controls the display unit 42 to display, as inspection results, the presence or absence of foreign matter or defects on the outer peripheral surface BA and the end surface BB, the type of the defect, and the length and diameter of the silicon single crystal block B on the display unit 42.

### Operation Of The Appearance Inspection Device

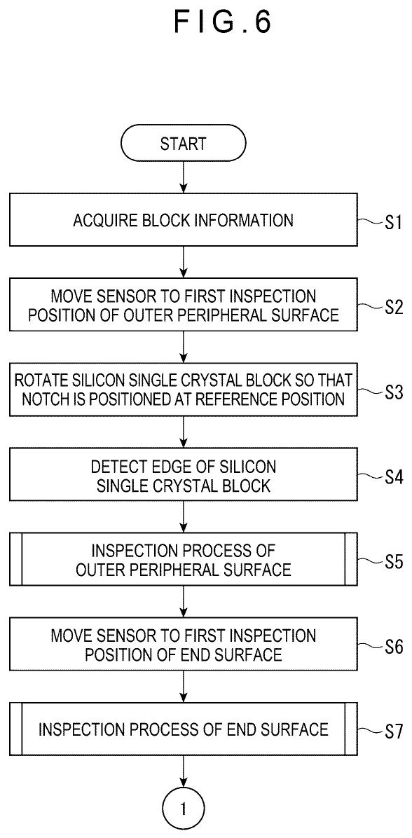

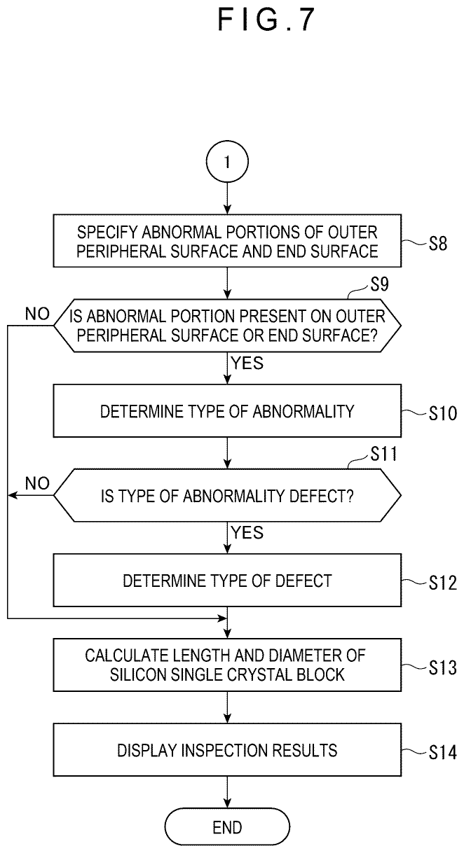

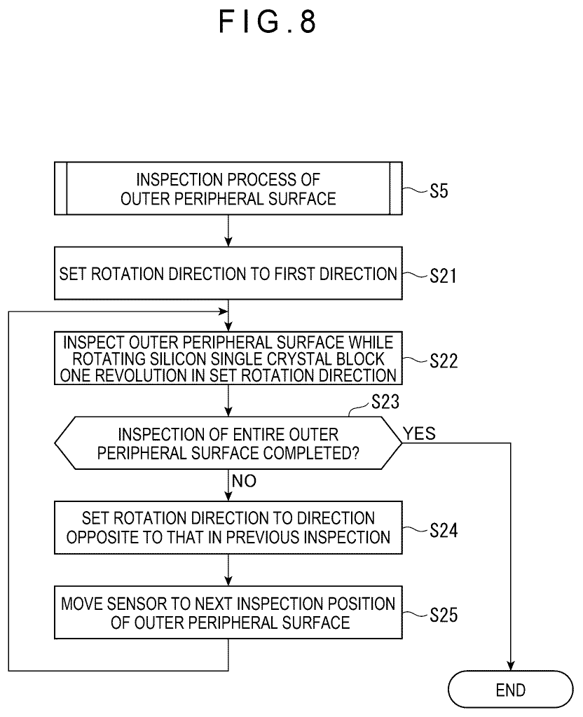

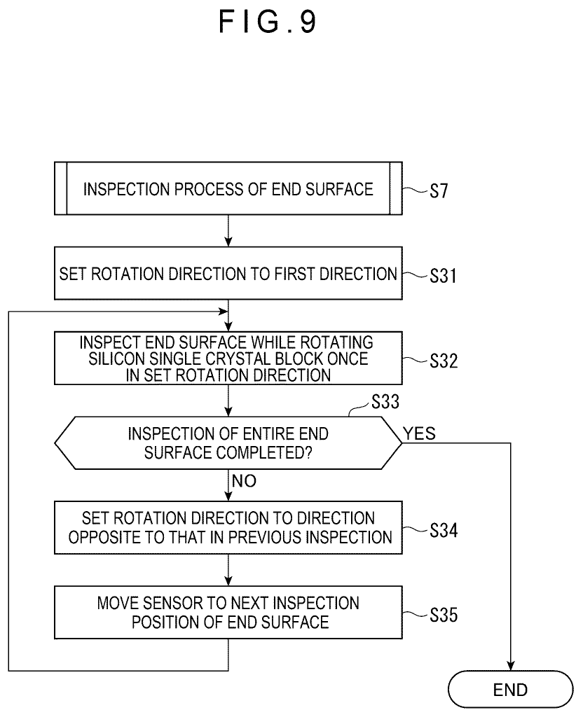

Subsequently, an appearance inspection process of the silicon single crystal block B, as the operation of the appearance inspection device 1, will be described. FIGS. 6 and 7 are flowcharts of the appearance inspection process. FIG. 8 is a flowchart of the inspection process of the outer peripheral surface. FIG. 9 is a flowchart of the inspection process of the end surface.

Steps S2 to S7 in FIG. 6, steps S21 to S25 in FIG. 8, and steps S31 to S35 in FIG. 9 constitute a surface inspection step. Among the steps constituting the above surface inspection step, steps S5 and S21 to S25 constitute an outer peripheral surface inspection step, and steps S7 and S31 to S35 constitute an end surface inspection step. Steps S8 to S12 in FIG. 7 constitute a determination step.

As illustrated in FIG. 1, a user or a transfer device (not illustrated) sets the silicon single crystal block B to be inspected on the pair of rotation rollers 21.

Before or after the silicon single crystal block B is set on the pair of rotation rollers 21, the block information acquisition unit 441 of the control unit 44, which constitutes the appearance inspection device 1, acquires block information as illustrated in FIG. 6 (step S1).

When the inspection control unit 442 of the control unit 44 receives an instruction to start inspection based on a user operation on the input unit 41, the inspection control unit 442 controls the six-axis robot 321 to move the sensor 31 to the first inspection position of the outer peripheral surface on the outer peripheral surface BA of the silicon single crystal block B (step S2).

The inspection control unit 442 rotates the silicon single crystal block B so that the notch BV is positioned at a reference position (step S3).

For example, the inspection control unit 442 controls the roller drive unit 22 to rotate the silicon single crystal block B one revolution in a first direction (a clockwise direction as viewed from the front), and also controls the irradiation portion 312 to irradiate the outer peripheral surface BA with blue laser light. The image processing unit 443, for example, during the rotation of the silicon single crystal block B, generates the two-dimensional image PA in which the outer peripheral surface BA and the notch BV are represented with different brightness levels, or the height image PB in which the outer peripheral surface BA and the notch BV are represented with different colors, based on the light-receiving state of reflected light at the light-receiving portion 313. The inspection control unit 442 controls the roller drive unit 22 based on the two-dimensional image PA or the height image PB to stop the rotation of the silicon single crystal block B so that the notch BV is positioned at the reference position.

As the reference position, an example may be a position where an angle formed between a first virtual line extending vertically upward from the central axis BC when the end surface BB is viewed from the front, and a second virtual line connecting the central axis BC and the center of the notch BV is zero degrees, but the position may also be other than zero degrees.

The inspection control unit 442 detects a position of the rear end surface BB when viewed from above, that is, an edge of the silicon single crystal block B (step S4).

For example, the inspection control unit 442 detects the edge of the silicon single crystal block B based on the two-dimensional image PA or the height image PB that was used when positioning the notch BV at the reference position.

The inspection control unit 442 performs the inspection process of the outer peripheral surface BA (step S5).

In the inspection process of the outer peripheral surface BA in step S5, the inspection control unit 442, as illustrated in FIG. 8, sets a rotation direction of the silicon single crystal block B to the first direction (step S21).

The inspection control unit 442 inspects the outer peripheral surface BA while rotating the silicon single crystal block B one revolution in the set rotation direction (step S22).

In step S22, the inspection control unit 442 controls the roller drive unit 22 to rotate the silicon single crystal block B one revolution in the set rotation direction, and also controls the irradiation portion 312 to irradiate the outer peripheral surface BA with blue laser light. When the inspection control unit 442 acquires a signal corresponding to a light-receiving state from the light-receiving portion 313, the inspection control unit 442 generates inspection information of the outer peripheral surface corresponding to an inspection position of the outer peripheral surface of the sensor 31, and stores the inspection information in the storage unit 43. When the inspection control unit 442 determines, based on the signal from the light-receiving portion 313, that the notch BV has returned to the reference position, the inspection control unit 442 stops the rotation of the silicon single crystal block B.

The inspection control unit 442 determines whether inspection of the entire outer peripheral surface BA has been completed (step S23). For example, the image processing unit 443 generates the two-dimensional image PA or the height image PB based on inspection information of the outer peripheral surface generated in step S22. When the inspection control unit 442 determines that the two-dimensional image PA or the height image PB includes the region C with no inspection object located on the front side of the end surface BB, the inspection control unit 442 determines that inspection of the entire outer peripheral surface BA has been completed (step S23: YES) and ends the inspection process of the outer peripheral surface BA.

On the other hand, when the two-dimensional image PA or the height image PB does not include the region C with no inspection object located on the front side of the end surface BB, the inspection control unit 442 determines that inspection of the entire outer peripheral surface BA has not been completed (step S23: NO), and sets the rotation direction of the silicon single crystal block B to an opposite direction to the previous inspection direction (step S24). That is, in step S24, when the set rotation direction in the previous inspection is the first direction, the inspection control unit 442 sets the rotation direction to a second direction, and when the set rotation direction in the previous inspection is the second direction, the inspection control unit 442 sets the rotation direction to the first direction.

In step S23, when inspection has been completed for a set number of times input based on a user operation on the input unit 41, the inspection control unit 442 may determine that inspection of the entire outer peripheral surface BA has been completed. When inspection has not been completed for the set number of times, the inspection control unit 442 may determine that inspection of the entire outer peripheral surface BA has not been completed.

The inspection control unit 442 controls the six-axis robot 321 to move the sensor 31 to a next inspection position of the outer peripheral surface (step S25).

In step S25, when the inspection position of the outer peripheral surface in the previous inspection is an E-th inspection position of the outer peripheral surface (where E is an integer equal to or greater than 1), the inspection control unit 442 moves the sensor 31 to the (E+1)-th inspection position of the outer peripheral surface.

After step S25, the inspection control unit 442 inspects the outer peripheral surface BA while rotating the silicon single crystal block B one revolution in the set rotation direction (step S22).

The inspection control unit 442 repeats the above steps until the inspection control unit 442 determines in step S23 that inspection of the entire outer peripheral surface BA has been completed.

When the inspection process of the outer peripheral surface BA in step S5 has been completed, the inspection control unit 442, as illustrated in FIG. 6, controls the six-axis robot 321 to move the sensor 31 to the first inspection position of the end surface facing the rear end surface BB of the silicon single crystal block B (step S6).

The inspection control unit 442 performs the inspection process of the end surface BB (step S7).

In the inspection process of the end surface BB in step S7, the inspection control unit 442, as illustrated in FIG. 9, sets the rotation direction of the silicon single crystal block B to the first direction in the same manner as in step S21 (step S31).

The inspection control unit 442 inspects the end surface BB while rotating the silicon single crystal block B one revolution in the set rotation direction (step S32).

In step S32, the inspection control unit 442 rotates the silicon single crystal block B one revolution in the set rotation direction and causes the irradiation portion 312 to irradiate the end surface BB with blue laser light. The inspection control unit 442 generates inspection information of the end surface corresponding to an inspection position of the end surface of the sensor 31 based on a signal corresponding to a light-receiving state from the light-receiving portion 313, and stores the inspection information in the storage unit 43.

The inspection control unit 442 determines whether inspection of the entire end surface BB has been completed (step S33). For example, the inspection control unit 442 calculates a set number of times until inspection is completed in a state where the lower end of the irradiation range H is positioned below the central axis BC and the upper end of the irradiation range H is positioned above the central axis BC, based on a radius of the silicon single crystal block B and a width of the irradiation range H. When inspection for the set number of times has been completed, the inspection control unit 442 determines that inspection of the entire end surface BB has been completed, and when inspection for the set number of times has not been completed, the inspection control unit 442 determines that inspection of the entire end surface BB has not been completed. The set number of times may be a number input based on a user operation on the input unit 41.

When the inspection control unit 442 determines that inspection of the entire end surface BB has been completed (step S33: YES), the inspection control unit 442 ends the inspection process of the end surface BB.

On the other hand, when the inspection control unit 442 determines that inspection of the entire end surface BB has not been completed (step S33: NO), the inspection control unit 442, in the same manner as in step S24, sets the rotation direction of the silicon single crystal block B to an opposite direction to the previous inspection direction (step S34).

The inspection control unit 442 controls the six-axis robot 321 to move the sensor 31 to a next inspection position of the end surface (step S35).

In step S35, when the inspection position of the end surface in the previous inspection is an E-th inspection position of the end surface (where F is an integer equal to or greater than 1), the inspection control unit 442 moves the sensor 31 to the (F+1)-th inspection position of the end surface.

After step S35, the inspection control unit 442 inspects the end surface BB while rotating the silicon single crystal block B one revolution in the set rotation direction (step S32).

The inspection control unit 442 repeats the above steps until the inspection control unit 442 determines in step S33 that inspection of the entire end surface BB has been completed.

When the inspection process of the end surface BB in step S7 has been completed, the determination unit 444, as illustrated in FIG. 8, specifies abnormal portions BE of the outer peripheral surface BA and the end surface BB (step S8).

Before step S8, the image processing unit 443 generates two-dimensional images PA corresponding to the respective inspection positions of the outer peripheral surface based on inspection information of the respective inspection positions of the outer peripheral surface. The image processing unit 443 generates two-dimensional images PA corresponding to the respective inspection positions of the end surface based on inspection information of the respective inspection positions of the end surface. The process in which the image processing unit 443 generates the two-dimensional images PA corresponding to inspection positions of the outer peripheral surface and the end surface constitutes an image processing step.

In step S8, the determination unit 444 specifies abnormal portions BE of regions irradiated with blue laser light from the respective inspection positions of the outer peripheral surface BA based on the two-dimensional images PA corresponding to the respective inspection positions of the outer peripheral surface BA. The determination unit 444 specifies abnormal portions BE of regions irradiated with blue laser light from the respective inspection positions of the end surface BB based on the two-dimensional images PA corresponding to the respective inspection positions of the outer peripheral surface.

The determination unit 444 determines whether the abnormal portion BE is present on the outer peripheral surface BA or the end surface BB based on the result specified in step S8 (step S9).

When the determination unit 444 determines that the abnormal portion BE is present on the outer peripheral surface BA or the end surface BB (step S9: YES), the determination unit 444 determines a type of abnormality (step S10).

Before step S10, when the abnormal portion BE is present on the outer peripheral surface BA, the image processing unit 443 generates the height image PB corresponding to a location where the abnormal portion BE is present, based on inspection information of the outer peripheral surface that was used to generate the two-dimensional image PA including the abnormal portion BE. When the abnormal portion BE is present on the end surface BB, the image processing unit 443 generates the height image PB corresponding to a location where the abnormal portion BE is present, based on inspection information of the end surface that was used to generate the two-dimensional image PA including the abnormal portion BE. The process in which the image processing unit 443 generates the height image PB corresponding to the location where the abnormal portion BE is present on each of the outer peripheral surface BA and the end surface BB constitutes the image processing step.

In step S10, the determination unit 444 determines, based on the height image PB generated by the image processing unit 443, whether the type of abnormality of the abnormal portion BE is a defect or foreign matter.

It should be noted that step S10 may also be performed as follows.

Before step S8, the image processing unit 443 generates the two-dimensional images PA and the height images PB corresponding to the respective inspection positions of the outer peripheral surface and the respective inspection positions of the end surface. In step S1, the determination unit 444 may select the height image PB corresponding to a location where the abnormal portion BE is present, from among the height images PB generated by the image processing unit 443, and may determine a type of abnormality based on the selected height image PB.

The determination unit 444 determines, based on the result of determination in step S10, whether the type of abnormality is a defect (step S11).

When the determination unit 444 determines that the type of abnormality is a defect (step S11: YES), the determination unit 444 determines a type of the defect (step S12).

When the determination unit 444 uses the cross-sectional shape image PC in step S12, the image processing unit 443 generates, before step S12, the cross-sectional shape image PC representing a cross-sectional shape of the defect based on the height image PB including the defect.

The determination unit 444 determines a type of the defect based on a parameter obtained from at least one of the height image PB or the cross-sectional shape image PC corresponding to a location where the defect is present, and a threshold value of that parameter.

When step S12 has been completed, when the determination unit 444 determines that no abnormal portion BE is present on the outer peripheral surface BA or the end surface BB (step S9: NO), or when the determination unit 444 determines that the type of abnormality is not a defect but is foreign matter (step S11: NO), the block shape calculation unit 445 calculates a length and a diameter of the silicon single crystal block B (step S13).

The display control unit 446 displays inspection results on the display unit 42 (step S14).

In step S13, the display control unit 446 may display, on the display unit 42, the presence or absence of foreign matter or defects and a type of defect as inspection results in the following manner.

The display control unit 446 displays, on the display unit 42, a developed figure of the outer peripheral surface BA on a plane and figures of both end surfaces BB. The display control unit 446 may display a location where the abnormal portion BE is present or a predetermined range including the abnormal portion BE in each of the figures, in a first color corresponding to foreign matter or a second color corresponding to defects, and may display other regions in a third color.

The display control unit 446 may also display, on the display unit 42, characters indicating positions of foreign matter or defects.

In step S14, the display control unit 446 displays, on the display unit 42, the length and diameter of the silicon single crystal block B as inspection results in characters.

### Effects of First Exemplary Embodiment

The rotation mechanism 2 of the appearance inspection device 1 rotates the cylindrical silicon single crystal block B one revolution in the circumferential direction of the silicon single crystal block B under the control of the controller 4. The sensor 31 irradiates, with laser light, a surface of the silicon single crystal block B being rotated in the circumferential direction and receives reflected laser light from the silicon single crystal block B. The image processing unit 443 of the control unit 44 included in the controller 4 generates the height image PB of the surface based on a light-receiving state of the reflected light in the sensor 31. The determination unit 444 of the control unit 44 determines characteristics of the surface based on the height image PB.

According to the appearance inspection device 1, without moving the sensor 31 in the circumferential direction of the silicon single crystal block B, the height image PB in the circumferential direction of the silicon single crystal block B can be generated simply by rotating the silicon single crystal block B in the circumferential direction. The appearance inspection device 1 can appropriately determine characteristics of the surface of the silicon single crystal block B based on the height image PB generated using laser light. It is therefore possible to provide the appearance inspection device 1 that can appropriately inspect the appearance of the silicon single crystal block B.

The appearance inspection device 1 includes the sensor moving mechanism 32 that moves the sensor 31 by a predetermined distance along a surface of the silicon single crystal block B. The appearance inspection device 1 rotates the silicon single crystal block B one revolution and then stops it. The appearance inspection device 1 repeats the following process: while the silicon single crystal block B makes one revolution, blue laser light is irradiated from the sensor 31 onto the surface of the silicon single crystal block B and reflected light reflected by the surface of the silicon single crystal block B is received by the sensor 31; and when the silicon single crystal block B has stopped, the sensor moving mechanism 32 moves the sensor 31 by the predetermined distance along the surface of the silicon single crystal block B.

Thus, if the surface to be inspected is the outer peripheral surface BA, even when the irradiation range H of the blue laser light in the sensor 31 is shorter than the length of the outer peripheral surface BA in the direction of the central axis BC, the sensor moving mechanism 32 moves the sensor 31 along the outer peripheral surface BA in a direction parallel to the central axis BC each time the silicon single crystal block B irradiated with the blue laser light makes one revolution. The entire outer peripheral surface BA can therefore be inspected. If the surface to be inspected is the outer peripheral surface BA, even when the irradiation range H of the blue laser light in the sensor 31 is shorter than the length of the outer peripheral surface BA in the direction of the central axis BC, the sensor moving mechanism 32 moves the sensor 31 along the outer peripheral surface BA in a direction parallel to the central axis BC each time the silicon single crystal block B irradiated with the blue laser light makes one revolution. The entire outer peripheral surface BA can therefore be inspected.

Accordingly, the appearance inspection device 1 can appropriately inspect the appearance of the silicon single crystal block B without using the sensor 31 having a wide irradiation range H of the blue laser light.

The sensor moving mechanism 32 includes the six-axis robot 321 that moves the single sensor 31 in the direction of the central axis BC along the outer peripheral surface BA of the silicon single crystal block B, and moves the sensor 31 in the radial direction of the silicon single crystal block B along the end surface BB. The appearance inspection device 1 inspects the entire outer peripheral surface BA by inspection performed while moving the sensor 31 in the direction of the central axis BC along the outer peripheral surface BA of the silicon single crystal block B, and then inspects the entire end surface BB by inspection performed while moving the sensor 31 in the radial direction of the silicon single crystal block B along the end surface BB.

Accordingly, the entire appearance of the silicon single crystal block B can be appropriately inspected by only using the single sensor 31.

The rotation mechanism 2 rotates the silicon single crystal block B one revolution in different directions alternately during inspection of the outer peripheral surface BA or the end surface BB.

Here, due to influences such as a shape of the outer peripheral surface BA of the silicon single crystal block B, a shape of the outer peripheral surface of the rotation roller 21, or parallelism of the pair of rotation rollers 21, the silicon single crystal block B may be displaced in the direction of the central axis BC when the silicon single crystal block B makes one revolution. In this case, when the silicon single crystal block B continues to make one revolution in the same direction during inspection of the outer peripheral surface BA or the end surface BB, the silicon single crystal block B is largely displaced from an inspection start position. When such positional deviation occurs, each time the silicon single crystal block B makes one revolution in the same direction during inspection of the outer peripheral surface BA, a deviation between an inspection position of the outer peripheral surface by the sensor 31 and a position in the direction of the central axis BC of the outer peripheral surface BA that has been preset for the inspection position of the outer peripheral surface becomes larger, which may make it impossible to appropriately inspect the outer peripheral surface BA. Each time the silicon single crystal block B makes one revolution in the same direction during inspection of the end surface BB, a deviation from the inspection distance K, which is a distance from the sensor 31 to the end surface BB, becomes larger, which may make it impossible to appropriately inspect the end surface BB.

As in the first exemplary embodiment, by rotating the silicon single crystal block B one revolution alternately in different directions during inspection of the outer peripheral surface BA, even when the silicon single crystal block B is displaced in the direction of the central axis BC through one rotation of the silicon single crystal block B, the silicon single crystal block B is displaced in the opposite direction during the next rotation in the opposite direction and returns to its original position. Accordingly, a deviation between an inspection position of the outer peripheral surface by the sensor 31 and a position in the direction of the central axis BC of the outer peripheral surface BA that has been preset for the inspection position of the outer peripheral surface can be minimized. By rotating the silicon single crystal block B one revolution alternately in different directions during inspection of the end surface BB, a deviation from the inspection distance K, which is a distance from the sensor 31 to the end surface BB, can be minimized for the same reason as during inspection of the outer peripheral surface BA.

Accordingly, the appearance inspection device 1 can appropriately inspect the appearance of the outer peripheral surface BA and the end surface BB of the silicon single crystal block B.

The sensor 31 irradiates the silicon single crystal block B having high reflectivity with blue laser light.

In this manner, by using blue laser light having a shorter wavelength than red laser light, a width of the irradiation range H can be reduced, which makes it possible for the appearance inspection device 1 to generate clear two-dimensional images PA and height images PB with reduced influence of scattering.

Accordingly, the appearance inspection device 1 can more appropriately inspect the appearance of the outer peripheral surface BA and the end surface BB of the silicon single crystal block B based on the clear two-dimensional image PA and height images PB.

The appearance inspection device 1 rotates the silicon single crystal block B one revolution with reference to the notch BV.

In this manner, the appearance inspection device 1 can control rotation of the silicon single crystal block B by a simple method that uses only the notch BV commonly provided in the silicon single crystal block B as a reference.

The appearance inspection device 1 generates the two-dimensional image PA of a surface of the silicon single crystal block B based on a light-receiving state of reflected blue laser light, specifies the abnormal portion BE on the surface based on the two-dimensional image PA, and determines whether a defect is present on the surface based on the height image PB of the specified abnormal portion BE.

Therefore, when no abnormal portion BE is present, the appearance inspection device 1 does not need to generate the height image PB, and can perform inspection efficiently.

### Second Exemplary Embodiment

### Configuration of Appearance Inspection Device

Configurations of an appearance inspection device according to a second exemplary embodiment of the invention will be described.

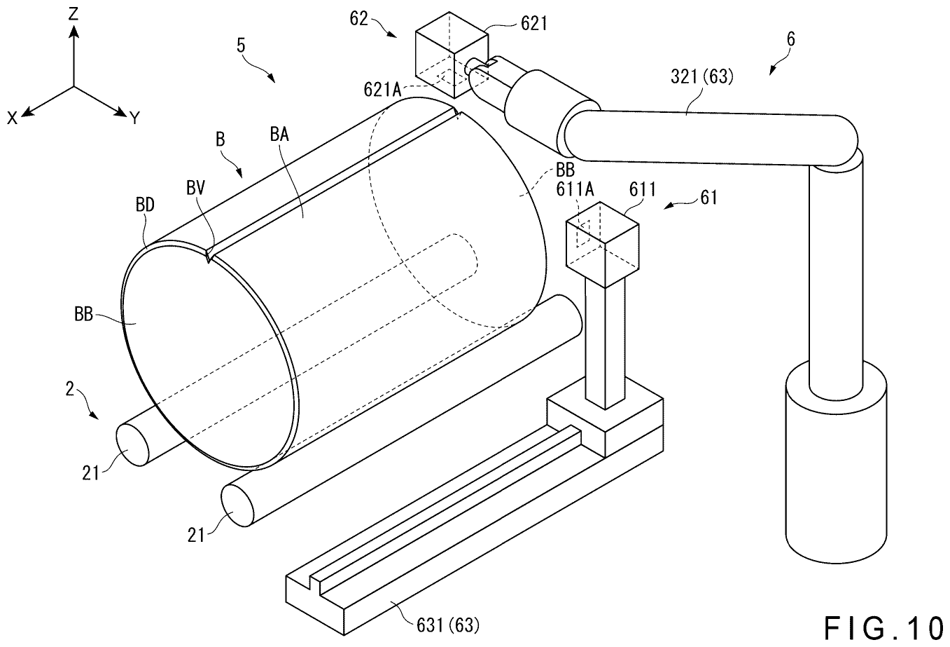

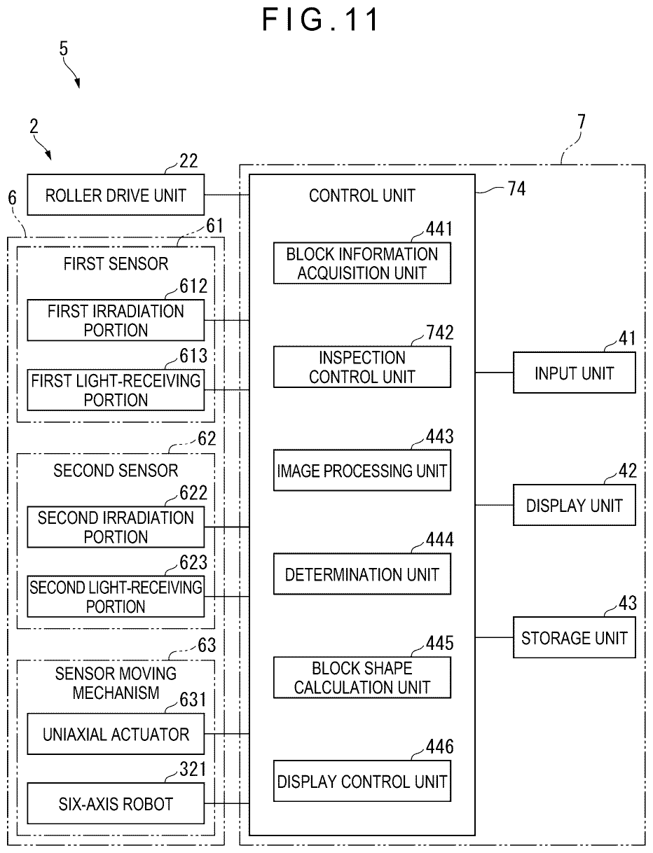

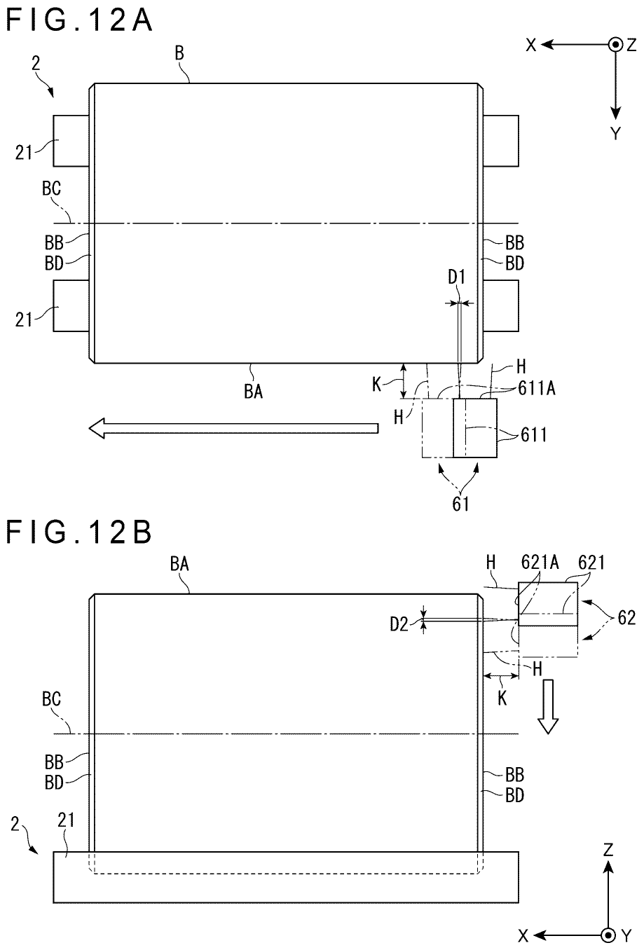

FIG. 10 is a perspective view illustrating a schematic configuration of the appearance inspection device of the second exemplary embodiment. FIG. 11 is a block diagram illustrating a schematic configuration of a control system of the appearance inspection device. FIG. 12A schematically illustrates a movement state of a sensor during inspection of an outer peripheral surface. FIG. 12B schematically illustrates a movement state of the sensor during inspection of an end surface.

The same names and the same reference numerals are given to the same configurations as those in the first exemplary embodiment, and a description thereof is simplified or omitted.

An appearance inspection device 5 illustrated in FIG. 10 inspects an appearance of the silicon single crystal block B in the same manner as the appearance inspection device 1 of the first exemplary embodiment.

As illustrated in FIGS. 10 and 11, the appearance inspection device 5 includes the rotation mechanism 2, an inspection unit 6, and a controller 7.

The inspection unit 6 includes a first sensor 61, a second sensor 62, and a sensor moving mechanism 63.

The first and second sensors 61 and 62 include the same configuration as the sensor 31 of the first exemplary embodiment. The first and second sensors 61 and 62 respectively include a first sensor main body 611 and a second sensor main body 621 having first and second light entrance/exit surface portions 611A and 621A, first and second irradiation portions 612 and 622 that irradiate blue laser light, and first and second light-receiving portions 613 and 623.

The first irradiation portion 612 of the first sensor 61 irradiates the outer peripheral surface BA with blue laser light. As illustrated in FIG. 12A, when a distance from the first light entrance/exit surface portion 611A to the outer peripheral surface BA is an inspection distance K, the blue laser light irradiated from the first light entrance/exit surface portion 611A is irradiated so that a length of the irradiation range H becomes shorter than a length in the front-rear direction of the outer peripheral surface BA.

The second irradiation portion 622 of the second sensor 62 irradiates the end surface BB with blue laser light. As illustrated in FIG. 12B, when a distance from the first light entrance/exit surface portion 611A to the end surface BB is an inspection distance K, the blue laser light irradiated from the second light entrance/exit surface portion 621A is irradiated so that a length of the irradiation range H becomes shorter than a radius of the end surface BB.

The first light-receiving portion 613 receives reflected light reflected by the outer peripheral surface BA and outputs a signal corresponding to a light-receiving state to the controller 7. The second light-receiving portion 623 receives reflected light from the end surface BB and outputs a signal corresponding to a light-receiving state to the controller 7.

The sensor moving mechanism 63 includes a uniaxial actuator 631 as a first moving mechanism and the six-axis robot 321 as a second moving mechanism.

The uniaxial actuator 631 holds the first sensor 61 and, under the control of the controller 7, moves the first sensor 61 in the front-rear direction at a right side of the outer peripheral surface BA of the silicon single crystal block B.

The six-axis robot 321 holds the second sensor 62 and, under the control of the controller 7, moves the second sensor 62 in the up-down direction at a position facing the rear end surface BB of the silicon single crystal block B.

As illustrated in FIG. 11, the controller 7 includes the input unit 41, the display unit 42, the storage unit 43, and a control unit 74. The roller drive unit 22, the first irradiation portion 612, the first light-receiving portion 613, the second irradiation portion 622, the second light-receiving portion 623, the uniaxial actuator 631, the six-axis robot 321, the input unit 41, the display unit 42, and the storage unit 43 are electrically connected to the control unit 74.

The control unit 74 has the same configuration as the control unit 44 of the first exemplary embodiment except that an inspection control unit 742 is different from the inspection control unit 442 of the first exemplary embodiment.

The inspection control unit 742 controls the roller drive unit 22 and the uniaxial actuator 631 to inspect the outer peripheral surface BA of the silicon single crystal block B. The inspection control unit 742 controls the roller drive unit 22 and the six-axis robot 321 to inspect the end surface BB of the silicon single crystal block B.

When inspecting the outer peripheral surface BA, the inspection control unit 742 controls the uniaxial actuator 631 to position the first sensor 61 at a first inspection position of the outer peripheral surface, in a state where the first light entrance/exit surface portion 611A faces the outer peripheral surface BA at the right side of the outer peripheral surface BA of the silicon single crystal block B, as illustrated by the solid line in FIG. 12A. The first inspection position of the outer peripheral surface in the second exemplary embodiment is different from the first inspection position of the outer peripheral surface in the first exemplary embodiment in that the inspection position in the second exemplary embodiment is located at the right side of the outer peripheral surface BA instead of at the upper side of the outer peripheral surface BA, but a position in the front-rear direction is the same as that of the first inspection position of the outer peripheral surface in the first exemplary embodiment. The inspection control unit 742 controls the roller drive unit 22 to rotate the silicon single crystal block B one revolution and causes the first irradiation portion 612 to irradiate the outer peripheral surface BA with blue laser light.

When the inspection control unit 742 acquires a signal corresponding to a light-receiving state from the first light-receiving portion 613 that has received reflected light reflected by the outer peripheral surface BA, the inspection control unit 742 generates first inspection information of the outer peripheral surface and stores the inspection information in the storage unit 43.

Thereafter, the inspection control unit 742 controls the uniaxial actuator 631 to sequentially move the first sensor 61 to an N-th inspection position of the outer peripheral surface along the central axis BC, as illustrated by a two-dot chain line in FIG. 12A (in FIG. 12A, only the first sensor 61 at a second inspection position of the outer peripheral surface is illustrated). The N-th inspection position of the outer peripheral surface in the second exemplary embodiment is different from the N-th inspection position of the outer peripheral surface in the first exemplary embodiment in that the N-th inspection position in the second exemplary embodiment is located at the right side of the outer peripheral surface BA instead of at the upper side of the outer peripheral surface BA, but a position in the front-rear direction is the same as that of the N-th inspection position of the outer peripheral surface in the first exemplary embodiment. That is, the N-th inspection position of the outer peripheral surface is a position such that an overlap width between the irradiation range H of the blue laser light irradiated from the N-th inspection position of the outer peripheral surface and the irradiation range H of the blue laser light irradiated from the (N−1)-th inspection position of the outer peripheral surface becomes a width D1. The width D1 is a value greater than 0 mm. Each time the first sensor 61 is positioned at the N-th inspection position of the outer peripheral surface, the inspection control unit 742 rotates the silicon single crystal block B one revolution, causes the first irradiation portion 612 to irradiate the outer peripheral surface BA with blue laser light, generates N-th inspection information of the outer peripheral surface, and stores the inspection information in the storage unit 43.

In the same manner as the inspection control unit 442 of the first exemplary embodiment, the inspection control unit 742 repeats the above process until inspection is completed in a state where the front end of the irradiation range H is located forward of the front end surface BB and the rear end of the irradiation range H is located on the outer peripheral surface BA.

When inspecting the end surface BB, the inspection control unit 742 controls the six-axis robot 321 to position the second sensor 62 at a first inspection position of the end surface, in a state where the second light entrance/exit surface portion 621A faces the end surface BB, as illustrated by the solid line in FIG. 12B. The first inspection position of the end surface in the second exemplary embodiment is the same as the first inspection position of the end surface in the first exemplary embodiment. The inspection control unit 742 rotates the silicon single crystal block B one revolution and causes the second irradiation portion 622 to irradiate the end surface BB with blue laser light.

When the inspection control unit 742 acquires a signal corresponding to a light-receiving state from the second light-receiving portion 623 that has received reflected light from the end surface BB, the inspection control unit 742 generates first inspection information of the end surface and stores the inspection information in the storage unit 43.

Thereafter, the inspection control unit 742 controls the six-axis robot 321 to sequentially move the second sensor 62 to an M-th inspection position of the end surface along a vertical direction, as illustrated by a two-dot chain line in FIG. 12B (in FIG. 12B, only the second sensor 62 at a second inspection position of the end surface is illustrated). The M-th inspection position of the end surface is a position such that an overlap width between the irradiation range H of the blue laser light irradiated from the M-th inspection position of the end surface and the irradiation range H of the blue laser light irradiated from the (M−1)-th inspection position of the end surface becomes the width D2. The width D2 is a value greater than 0 mm, and may be the same as the width D1 or may be different from the width D1. That is, a first distance by which the first sensor 61 moves and a second distance by which the second sensor 62 moves may be the same or may be different. Each time the second sensor 62 is positioned at the M-th inspection position of the end surface, the inspection control unit 742 rotates the silicon single crystal block B one revolution, causes the second irradiation portion 622 to irradiate the end surface BB with blue laser light, generates M-th inspection information of the end surface, and stores the inspection information in the storage unit 43.

In the same manner as the inspection control unit 442 of the first exemplary embodiment, the inspection control unit 742 repeats the above process until inspection is completed in a state where the lower end of the irradiation range H is located below the central axis BC and the upper end of the irradiation range H is located above the central axis BC.

### Operation of the Appearance Inspection Device

Subsequently, an appearance inspection process of the silicon single crystal block B, as the operation of the appearance inspection device 5, will be described.

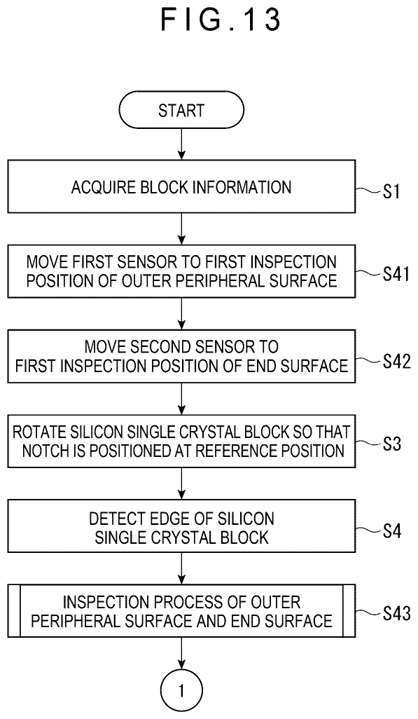

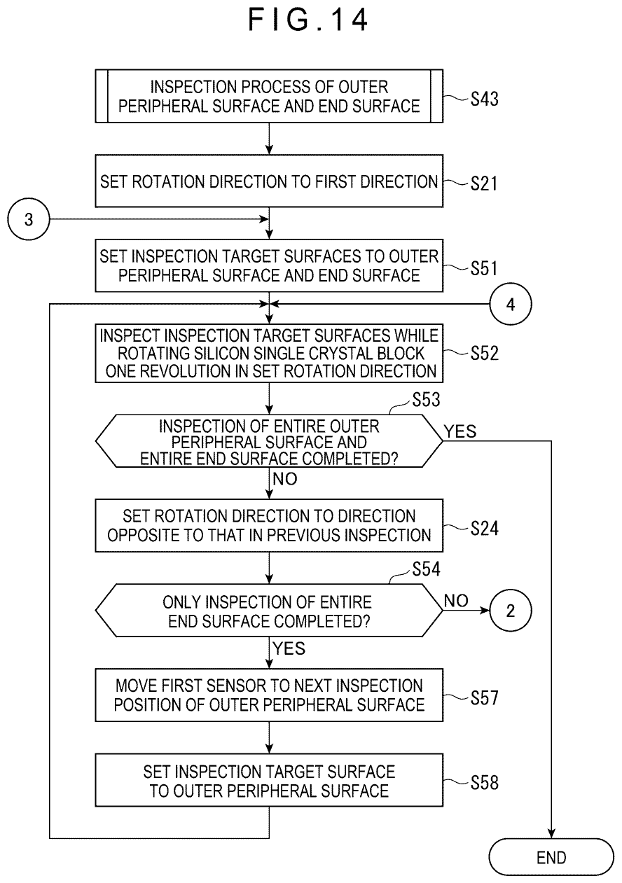

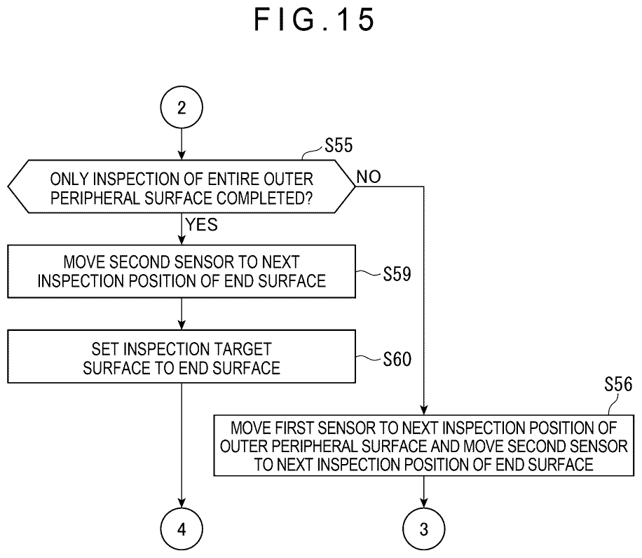

FIG. 13 is a flowchart of the appearance inspection process. FIGS. 14 and 15 are flowcharts of the inspection process of the outer peripheral surface and the end surface.

The same reference numerals are given to the same processes as those in the first exemplary embodiment, and a description thereof is simplified or omitted.

Steps S41, S42, S3, S4, and S43 in FIG. 13, steps S21, S51, S52, S53, S24, S54, S57, and S58 in FIG. 14, and steps S55, S56, S59, and S60 constitute the surface inspection step.

Before or after the silicon single crystal block B is set on the pair of rotation rollers 21, the block information acquisition unit 441 of the control unit 74, which constitutes the appearance inspection device 5, acquires block information as illustrated in FIG. 13 (step S1).

When the inspection control unit 742 of the control unit 74 receives an instruction to start inspection, the inspection control unit 742 controls the uniaxial actuator 631 to move the first sensor 61 to the first inspection position of the outer peripheral surface on the right side of the outer peripheral surface BA of the silicon single crystal block B (step S41).

The inspection control unit 742 controls the six-axis robot 321 to move the second sensor 62 to the first inspection position of the end surface facing the rear end surface BB of the silicon single crystal block B (step S42).

The inspection control unit 742 may perform step S42 before step S41, or may perform step S42 in parallel with step S41.

The inspection control unit 742 rotates the silicon single crystal block B so that the notch BV is positioned at a reference position (step S3).

The inspection control unit 742 detects an edge of the silicon single crystal block B (step S4).

The inspection control unit 742 performs the inspection process of the outer peripheral surface BA and the end surface BB (step S43).

In the inspection process of the outer peripheral surface BA and the end surface BB in step S43, the inspection control unit 742, as illustrated in FIG. 14, sets the rotation direction of the silicon single crystal block B to the first direction (step S21).

The inspection control unit 742 sets inspection target surfaces to the outer peripheral surface BA and the end surface BB (step S51).

The inspection control unit 742 inspects the inspection target surfaces while rotating the silicon single crystal block B one revolution in the set rotation direction (step S52).

In step S52, the inspection control unit 742 controls the roller drive unit 22 to rotate the silicon single crystal block B one revolution in the set rotation direction.

When the inspection target surfaces include the outer peripheral surface BA, the inspection control unit 742 controls the first irradiation portion 612 to irradiate the outer peripheral surface BA with blue laser light while the silicon single crystal block B is rotated, and when the inspection control unit 742 acquires a signal corresponding to a light-receiving state from the first light-receiving portion 613, the inspection control unit 742 generates inspection information of the outer peripheral surface corresponding to an inspection position of the outer peripheral surface by the first sensor 61 and stores the inspection information in the storage unit 43.

When the inspection target surfaces include the end surface BB, the inspection control unit 742 controls the second irradiation portion 622 to irradiate the end surface BB with blue laser light while the silicon single crystal block B is rotated, and when the inspection control unit 742 acquires a signal corresponding to a light-receiving state from the second light-receiving portion 623, the inspection control unit 742 generates inspection information of the end surface corresponding to an inspection position of the end surface by the second sensor 62 and stores the inspection information in the storage unit 43.

The inspection control unit 742 determines whether both inspection of the entire outer peripheral surface BA and inspection of the entire end surface BB have been completed (step S53). As criteria in step S53, the same criteria as those in steps S23 and S33 of the first exemplary embodiment can be exemplified.

When the inspection control unit 742 determines that inspection of both the entire outer peripheral surface BA and the entire end surface BB has been completed (step S53: YES), the inspection control unit 742 ends the inspection process of the outer peripheral surface BA and the end surface BB.

When the inspection control unit 742 determines that inspection of at least one of the entire outer peripheral surface BA or the entire end surface BB has not been completed (step S53: NO), the inspection control unit 742 sets the rotation direction of the silicon single crystal block B to an opposite direction to the previous inspection direction (step S24).

The inspection control unit 742 determines whether only inspection of the entire end surface BB has been completed (step S54).

When the inspection control unit 742 determines that only inspection of the entire end surface BB has not been completed (step S54: NO), the inspection control unit 742 determines whether only inspection of the entire outer peripheral surface BA has been completed, as illustrated in FIG. 15 (step S55).

When the inspection control unit 742 determines that only inspection of the entire outer peripheral surface BA has not been completed (step S55: NO), that is, when the inspection control unit 742 determines that inspection of both the entire outer peripheral surface BA and the entire end surface BB has not been completed, the inspection control unit 742 controls the uniaxial actuator 631 to move the first sensor 61 to a next inspection position of the outer peripheral surface and controls the six-axis robot 321 to move the second sensor 62 to a next inspection position of the end surface (step S56).

As illustrated in FIG. 14, the inspection control unit 742 sets the inspection target surfaces to the outer peripheral surface BA and the end surface BB (step S51), and inspects the inspection target surfaces while rotating the silicon single crystal block B one revolution in the set rotation direction (step S52).

When the inspection control unit 742 determines that only inspection of the entire end surface BB has been completed (step S54: YES), the inspection control unit 742 controls the uniaxial actuator 631 to move the first sensor 61 to a next inspection position of the outer peripheral surface (step S57).

The inspection control unit 742 sets the inspection target surface to the outer peripheral surface BA (step S58) and inspects the inspection target surface while rotating the silicon single crystal block B one revolution in the set rotation direction (step S52).

As illustrated in FIG. 15, when the inspection control unit 742 determines that only inspection of the entire outer peripheral surface BA has been completed (step S55: YES), the inspection control unit 742 controls the six-axis robot 321 to move the second sensor 62 to a next inspection position of the end surface (step S59).

The inspection control unit 742 sets the inspection target surface to the end surface BB (step S60) and, as illustrated in FIG. 14, inspects the inspection target surface while rotating the silicon single crystal block B one revolution in the set rotation direction (step S52).

The inspection control unit 742 repeats the above steps until the inspection control unit 742 determines in step S53 that inspection of both the entire outer peripheral surface BA and the entire end surface BB has been completed.

When the inspection process of the outer peripheral surface BA and the end surface BB in step S43 has been completed, the control unit 74 performs steps S8 to S14 illustrated in FIG. 7.

### Effects of Second Exemplary Embodiment

The appearance inspection device 5 can achieve the following effects in addition to the same effects as the appearance inspection device 1 of the first exemplary embodiment.

The appearance inspection device 5 includes the sensor moving mechanism 63 having the uniaxial actuator 631 that moves the first sensor 61 in the direction of a central axis BC of the silicon single crystal block B along the outer peripheral surface BA, and the six-axis robot 321 that moves the second sensor 62 in the radial direction of the silicon single crystal block B along the end surface BB. The appearance inspection device 5 rotates the silicon single crystal block B one revolution and stops it, and while the silicon single crystal block B makes one revolution, irradiates the outer peripheral surface BA with blue laser light from the first sensor 61 and receives reflected light with the first sensor 61, and irradiates the end surface BB with blue laser light from the second sensor 62 and receives reflected light with the second sensor 62. When the silicon single crystal block B has stopped, the appearance inspection device 1 repeats the process of moving the first sensor 61 along the outer peripheral surface BA by the first distance in the direction of the central axis BC of the silicon single crystal block B and moving the second sensor 62 along the end surface BB by the second distance in the radial direction of the silicon single crystal block B.

In this manner, by simultaneously inspecting the outer peripheral surface BA and the end surface BB while the silicon single crystal block B is rotated, the appearance inspection device 5 can improve inspection efficiency.

### Modifications

As described above, the exemplary embodiments of the invention have been explained in detail with reference to the drawings. However, the specific configurations are not limited to these exemplary embodiments, and various modifications and design changes within a scope not departing from the gist of the invention are included in the invention.

For example, in the first exemplary embodiment, the appearance inspection device 1 may be configured to inspect only the outer peripheral surface BA or only the end surface BB of the silicon single crystal block B. When the appearance inspection device 1 is configured to inspect only the outer peripheral surface BA, the appearance inspection device 1 may omit the sensor moving mechanism 32 by making a width of the irradiation range H of blue laser light from the sensor 31 longer than a length of the outer peripheral surface BA in the direction of the central axis BC. When the appearance inspection device 1 is configured to inspect only the end surface BB, the appearance inspection device 1 may omit the sensor moving mechanism 32 by making a width of the irradiation range H of blue laser light from the sensor 31 longer than a length of the end surface BB in the radial direction.

In the second exemplary embodiment, the appearance inspection device 5 may omit the uniaxial actuator 631 by making a width of the irradiation range H of blue laser light from the first sensor 61 longer than a length of the outer peripheral surface BA in the direction of the central axis BC, and the appearance inspection device 5 may omit the six-axis robot 321 by making a width of the irradiation range H of blue laser light from the first sensor 61 longer than a length of the end surface BB in the radial direction.

In the first exemplary embodiment, instead of the six-axis robot 321, a three-axis robot that moves the sensor 31 in the front-rear direction or the up-down direction and rotates the sensor 31 around one axis may be applied.

In the second exemplary embodiment, the six-axis robot 321 may be applied as a configuration for moving the first sensor 61, and the uniaxial actuator 631 may be applied as a configuration for moving the second sensor 62, or a linear moving mechanism other than the uniaxial actuator 631 or a three-axis robot may be applied as a configuration for moving the first and second sensors 61 and 62.

In the first and second exemplary embodiments, the rotation direction of the silicon single crystal block B is changed each time the silicon single crystal block B makes one revolution. However, when an amount of displacement of the silicon single crystal block B caused by one revolution is extremely small, the rotation direction of the silicon single crystal block B may be changed each time the silicon single crystal block B makes one revolution in the same direction a plurality of times, or the silicon single crystal block B may continue to be rotated in the same direction. When the silicon single crystal block B has no displacement caused by one revolution, the silicon single crystal block B may continue to be rotated in the same direction.

In the first and second exemplary embodiments, instead of the notch BV, the silicon single crystal block B may be formed to have an orientation flat, and the silicon single crystal block B may make one revolution with the orientation flat as a reference.

In the first and second exemplary embodiments, red laser light may be used instead of blue laser light.

In the second exemplary embodiment, the width of the irradiation range H of the first sensor 61 and the width of the irradiation range H of the second sensor 62 may be different from each other.

In the first and second exemplary embodiments, at least one of the two-dimensional image PA or the cross-sectional shape image PC may not be generated.

In the first and second exemplary embodiments, an inspection object is not limited to the silicon single crystal block B, and as long as it is solid or hollow cylindrical, its material is not limited.

### EXPLANATION OF CODES

1, 5 . . . appearance inspection device, 2 . . . rotation mechanism, 31 . . . sensor, 32, 63 . . . sensor moving mechanism, 61 . . . first sensor, 62 . . . second sensor, 321 . . . six-axis robot (second moving mechanism) , 443 . . . image processing unit, 444 . . . determination unit, 631 . . . uniaxial actuator (first moving mechanism), B . . . silicon single crystal block, BA . . . outer peripheral surface, BB . . . end surface, BC . . . central axis, BD . . . chamfered portion, BE . . . abnormal portion, BV . . . notch, PA . . . two-dimensional image, PB . . . height image, PC . . . cross-sectional shape image.

1. An appearance inspection device configured to inspect an appearance of a solid or hollow cylindrical inspection object, the device comprising:
a rotation mechanism configured to rotate the inspection object in a circumferential direction of the inspection object;
a sensor configured to irradiate, with laser light, a surface of the inspection object being rotated in the circumferential direction and to receive reflected light of the laser light reflected by the surface of the inspection object;
an image processing unit configured to generate a height image of the surface based on a light-receiving state of the reflected light; and
a determination unit configured to determine a characteristic of the surface based on the height image.

2. The appearance inspection device according to claim 1, further comprising a sensor moving mechanism configured to move the sensor along the surface,
wherein the rotation mechanism is configured to rotate the inspection object one revolution at a time in the circumferential direction,
the sensor is configured to irradiate the surface with the laser light and to receive the reflected light reflected by the surface of the inspection object while the inspection object makes one revolution, and
the sensor moving mechanism is configured to move the sensor along the surface by a predetermined distance each time the inspection object makes one revolution.

3. The appearance inspection device according to claim 2,
wherein the rotation mechanism is configured to change a rotation direction to an opposite direction each time the inspection object is rotated one revolution in an identical direction for a predetermined number of times.

4. The appearance inspection device according to claim 2,
wherein the sensor is a single sensor,
the surface includes an outer peripheral surface and an end surface, and
the sensor moving mechanism is configured to move the single sensor along the outer peripheral surface in a direction parallel to a central axis of the inspection object, and to move the single sensor along the end surface in a radial direction of the inspection object.

5. The appearance inspection device according to claim 2,
wherein the sensor includes a first sensor and a second sensor,
the surface includes an outer peripheral surface and an end surface, and
the sensor moving mechanism includes a first moving mechanism configured to move the first sensor along the outer peripheral surface in a direction parallel to a central axis of the inspection object; and a second moving mechanism configured to move the second sensor along the end surface in a radial direction of the inspection object.

6. The appearance inspection device according to claim 1,
wherein the laser light is blue laser light.

7. The appearance inspection device according to claim 1,
wherein the image processing unit is configured to generate a two-dimensional image of the surface based on the light-receiving state of the reflected light, and
the determination unit is configured to specify an abnormal portion on the surface based on the two-dimensional image, and to determine whether a defect is present on the surface based on the height image of the abnormal portion specified.

8. An appearance inspection method for inspecting an appearance of a solid or hollow cylindrical inspection object, the method comprising:
performing a surface inspection by rotating the inspection object one revolution in a circumferential direction thereof, irradiating a surface of the inspection object being rotated in the circumferential direction with laser light from a sensor, and receiving reflected light of the laser light reflected by the surface of the inspection object with the sensor;
performing an image generation by generating a height image of the surface based on a light-receiving state of the reflected light; and
performing a determination by determining a characteristic of the surface based on the height image.

9. The appearance inspection method according to claim 8,
wherein the surface inspection includes:
rotating the inspection object one revolution in the circumferential direction and then stopping the inspection object; and
repeating a process of: while the inspection object makes one revolution, irradiating the surface with the laser light from the sensor and receiving the reflected light reflected by the surface with the sensor; and when the inspection object has stopped, moving the sensor along the surface by a predetermined distance.

10. The appearance inspection method according to claim 8,
wherein the sensor is a single sensor,
the surface includes an outer peripheral surface and an end surface,
the surface inspection includes an outer peripheral surface inspection and an end surface inspection performed before or after the outer peripheral surface inspection,
the outer peripheral surface inspection includes:
rotating the inspection object one revolution in the circumferential direction and then stopping the inspection object; and
repeating a process of: while the inspection object makes one revolution, irradiating the outer peripheral surface with the laser light from the single sensor and receiving the reflected light reflected by the outer peripheral surface with the single sensor; and when the inspection object has stopped, moving the single sensor along the outer peripheral surface by a predetermined distance in a direction parallel to a central axis of the inspection object, and
the end surface inspection includes:
rotating the inspection object one revolution in the circumferential direction and then stopping the inspection object; and
repeating a process of: while the inspection object makes one revolution, irradiating the end surface with the laser light from the single sensor and receiving the reflected light reflected by the end surface with the single sensor; and when the inspection object has stopped, moving the single sensor along the end surface by a predetermined distance in a radial direction of the inspection object.

11. The appearance inspection method according to claim 8,
wherein the sensor includes a first sensor and a second sensor,
the surface includes an outer peripheral surface and an end surface, and
the surface inspection includes:
rotating the inspection object one revolution in the circumferential direction and then stopping the inspection object; and
repeating a process of: while the inspection object makes one revolution, irradiating the outer peripheral surface with the laser light from the first sensor and receiving the reflected light reflected by the outer peripheral surface with the first sensor, and irradiating the end surface with the laser light from the second sensor and receiving the reflected light reflected by the end surface with the second sensor; and when the inspection object has stopped, moving the first sensor along the outer peripheral surface by a first distance in a direction parallel to a central axis of the inspection object and moving the second sensor along the end surface by a second distance in a radial direction of the inspection object.

12. The appearance inspection method according to claim 9,
wherein the surface inspection includes changing a rotation direction of the inspection object to an opposite direction each time the inspection object is rotated one revolution in an identical direction for a predetermined number of times.

13. The appearance inspection method according to claim 12,
wherein the inspection object is a silicon single crystal block having the solid cylindrical shape obtained by cutting a silicon single crystal.

14. The appearance inspection method according to claim 13,
wherein the surface inspection includes detecting a notch of the silicon single crystal block when the inspection object is rotated one revolution in the circumferential direction, and rotating the silicon single crystal block one revolution with reference to the notch.

15. The appearance inspection method according to claim 13,
wherein the laser light is blue laser light.

16. The appearance inspection method according to claim 8,
wherein the image generation includes generating a two-dimensional image of the surface based on the light-receiving state of the reflected light, and
the determination includes specifying an abnormal portion on the surface based on the two-dimensional image, and determining whether a defect is present on the surface based on the height image of the abnormal portion specified.
